(19) United States
(12) Patent Application Publication
(10) Pub. No.: US 2006/0245370 A1
(43) Pub. Date: Nov. 2, 2006

(54) Method of quality of service reduction

(76) Inventor: Murali Ranganathan, Phoenix, AZ (US)

Correspondence Address: MOTOROLA, INC., LAW DEPARTMENT, 1303 E. ALGONQUIN ROAD, SCHAUMBURG, IL, 60196, US

(21) Appl. No.: 11/116,670

(22) Filed: Apr. 27, 2005

(51) Int. Cl. H04J 1/16; H04B 7/216

(52) U.S. Cl. 370/252; 370/335; 370/342

(57) ABSTRACT

A method of quality of service reduction between a mobile station (202) and a base station (206) in a wireless communication system (100) may include monitoring a reverse link (224) of a wireless communication session (120) for inactivity. If the inactivity is detected on the reverse link, identifying a user (203) of the wireless communication session as at least one of an inattentive user and a dormant user and measuring a forward link FER (223) of the wireless communication session corresponding to the reverse link. If the forward link FER is less than an FER threshold, decreasing the quality of service of the forward link.

### BACKGROUND OF INVENTION

In the prior art, when wireless users are in a communications session such as conference call, for a long period of time with their microphones muted, only eighth rate frames are being sent on the reverse link to the base station. Even though these “inattentive” users are consuming minimal capacity on the reverse link, they are being served at the normal quality of service (QoS) on the forward link, as are active members of the conference. Serving these inattentive users at the normal QoS has the disadvantage of reducing forward link capacity and potentially causing unnecessary interference to other mobile stations coupled to the base station.

Also in the prior art, when wireless data users are in a dormant state, they are also being served with a high forward link QoS although dormancy leads to an eventual termination of the communication session when a dormancy timer expires. With dormancy timers being anywhere from 30 to 60 seconds and longer in, for example, push-to-talk sessions, forward link capacity is again wasted during the expiration of the dormancy timer.

Accordingly, it would be highly desirable to have method of reducing quality of service of a forward link for an inattentive user and a dormant user in a wireless communication system.

### BRIEF DESCRIPTION OF THE DRAWINGS

Representative elements, operational features, applications and/or advantages of the present invention reside inter alia in the details of construction and operation as more fully hereafter depicted, described an d claimed—reference being made to the accompanying drawings forming a part hereof, wherein like numerals refer to like parts throughout. Other elements, operational features, applications and/or advantages will become apparent in light of certain exemplary embodiments recited in the Detailed Description, wherein:

FIG. 1 representatively illustrates a wireless communication system in accordance with an exemplary embodiment of the present invention;

FIG. 2 representatively illustrates a wireless communication system in accordance with an exemplary embodiment of the present invention;

FIG. 3 representatively illustrates a graphical representation of a method of the invention in accordance with an exemplary embodiment of the present invention;

FIG. 4 representatively illustrates a flow diagram in accordance with an exemplary embodiment of the present invention; and

FIG. 5 representatively illustrates a flow diagram in accordance with an exemplary embodiment of the present invention.

Elements in the Figures are illustrated for simplicity and clarity and have not necessarily been drawn to scale. For example, the dimensions of some of the elements in the Figures may be exaggerated relative to other elements to help improve understanding of various embodiments of the present invention. Furthermore, the terms “first”, “second”, and the like herein, if any, are used inter alia for distinguishing between similar elements and not necessarily for describing a sequential or chronological order. Moreover, the terms “front”, “back”, “top”, “bottom”, “over”, “under”, and the like in the Description and/or in the Claims, if any, are generally employed for descriptive purposes and not necessarily for comprehensively describing exclusive relative position. Any of the preceding terms so used may be interchanged under appropriate circumstances such that various embodiments of the invention described herein may be capable of operation in other configurations and/or orientations than those explicitly illustrated or otherwise described.

### DETAILED DESCRIPTION OF EXEMPLARY EMBODIMENTS

The following representative descriptions of the present invention generally relate to exemplary embodiments and the inventor's conception of the best mode, and are not intended to limit the applicability or configuration of the invention in any way. Rather, the following description is intended to provide convenient illustrations for implementing various embodiments of the invention. As will become apparent, changes may be made in the function and/or arrangement of any of the elements described in the disclosed exemplary embodiments without departing from the spirit and scope of the invention.

A detailed description of an exemplary application, namely a method of quality of service reduction, is provided as a specific enabling disclosure that may be generalized to any application of the disclosed system, device and method in accordance with various embodiments of the present invention.

In a code division multiple access (CDMA) mobile telecommunication system, power control bits (PCB's) are continuously transmitted by both mobile stations and base stations to the other requesting that the entity at the other end of the mobile link power up or power down. Typically each mobile unit continuously sends power control bits to the base station requesting that the base station transmit its information with greater power since the signal being received is fading.

A frame erasure rate (FER) measures the number of data frames transmitted by the base station to the mobile unit, which are received in error on the forward link. A typical scenario for high frame erasure rates consists of a moving mobile unit that loses a good line-of-site coupling with the base station. The scenario is that the mobile unit transmits consecutive requests for powering up by the base station of its forward link transmissions to the mobile unit. Such powering up on the forward link presents more interference to other mobile units in line-of-sight communication with the base station or another base station, which this causes the base station to use excessive power for one particular mobile unit.

Wireless communication systems are well known and consist of many types including land mobile radio, cellular radiotelephone (inclusive of analog cellular, digital cellular, personal communication systems (PCS) and wideband digital cellular systems), and other communication system types. In cellular radiotelephone communication systems, for example, a number of communication cells are typically comprised of one or more Base Stations (BS's) coupled to one or more Base Station Controllers (BSCs) or Central Base Station Controllers (CBSCs) and forming a Radio Access Network (RAN). The BSCs or CBSCs are, in turn, coupled to a Mobile Switching Center (MSC) that provides a connection between the RAN and an external network, such as a Public Switched Telephone Network (PSTN), as well as interconnection to other RANs. Each BS provides communication services to a mobile station (MS) located in a coverage area serviced by the BS via a communication resource that includes a forward link for transmitting signals to, and a reverse link for receiving signals from, the MS.

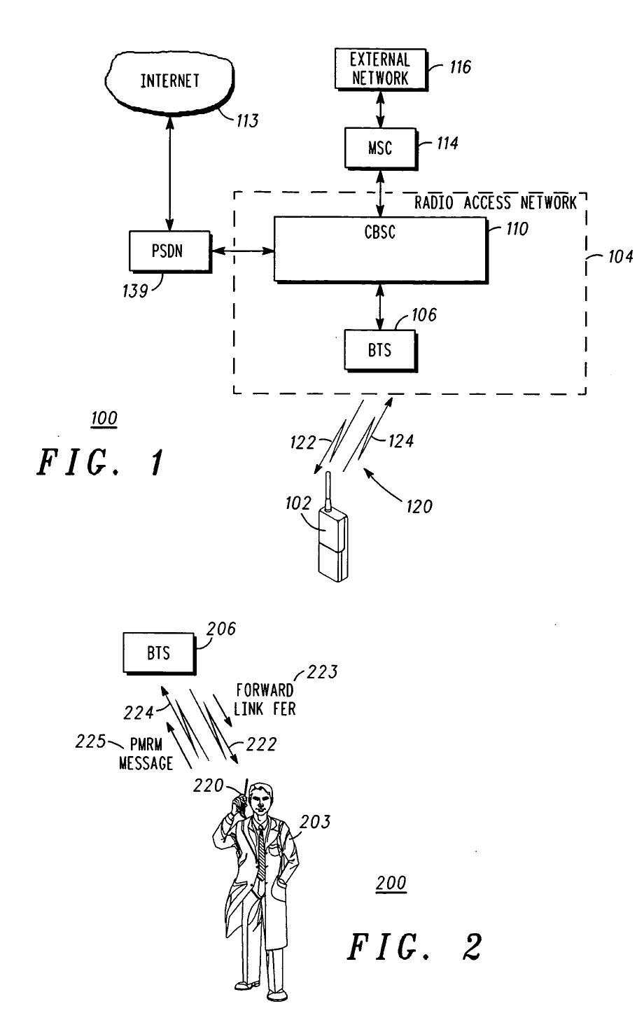

FIG. 1 representatively illustrates a wireless communication system in accordance with an exemplary embodiment of the present invention. Wireless communication system 100 includes a RAN 104 comprising at least one base station (BS) 106 that is coupled to a CBSC 110. RAN 104 is coupled to an MSC 114, and MSC 114 is in turn coupled to an external network 116 and provides a communication link between the external network, or other RANs, and RAN 104. In an embodiment, RAN 104 may be a CDMA network.

Wireless communication system 100 may further include a mobile station 102 coupled to BS 106 via wireless link. In an embodiment, wireless link may include a forward link 122 for communications from BS 106 to mobile station 102, and reverse link 124 for communications from mobile station 102 to BS 106.

In an embodiment, RAN 104 may be coupled to a PDSN 139, which is coupled to operate as the gateway from the RAN 104 into a public and/or private packet network, for example and without limitation, the Internet 113.

In an embodiment, PDSN 139 may act as a network access server, home agent, foreign agent, and the like. PDSN 139 may manage the radio-packet interface between RAN 104 and Internet 113, provide IP addresses for the subscriber's mobile station 102, perform packet routing, actively manage subscriber services based on profile information, authenticate users, and the like.

It is the object of forward link power control (FLPC) to assign reasonable power to forward traffic channels, and to minimize the interference with other users in the same cell and with the users in adjacent cells on the condition of ensuring the communication quality. Namely, the forward channel transmitting power should be as lower as possible on the condition that minimal required signal-to-noise ratio for demodulation in mobile stations is met. The adjustment of forward power control not only eliminates the “distance” effect, but also reduces the forward transmitting power to a minimum, depresses the interference with other users and increases the forward link capacity with communication quality ensured.

In IS-95 systems, FLPC tends to make every traffic channel transmit the lowest power under the condition that the desired frame error rate (FER) demanded by a mobile station is obtained. The mobile station continuously measures the FER in forward traffic channels and reports the power measurement report message up to the base station at a certain interval or at the time when the FER reaches a given threshold. Based on the FER report, the base station increases or decreases the transmitting power in the forward traffic channel with appropriate means. Of course, the base station limits the dynamic range of transmitting power in every traffic channel to guarantee the power to be under a maximum for not generating stronger interference and to be above a minimum for ensuring communication quality.

For RC1, the base station adjusts the transmitting power in forward channel based on the power measurement report message (PMRM) from the mobile station. The threshold report mode is used in IS-95 systems. In essence, based on the power threshold report, the quality of the current frame is determined indirectly, and the increase or decrease of power is decided thereby.

For RC2, besides by using PMRM, the base station adjusts the forward channel transmitting power by the erasure indication bit (EIB) in every reverse traffic frame via the codes received from the mobile station (EIB indicates whether the mobile station has received the last forward traffic data frame correctly). Since the reception of EIB is performed in every frame, it is obvious that the control period for adjustment of forward channel power by EIB is at least 20 ms. It is seen that forward power control in IS-95A systems is a type of slow control mode with the control rate not higher than 50 Hz.

In CDMA2000-1X systems, when a mobile station enters a fast Rayleigh fading area, the previous slow FLPC will no longer meet the requirements. Compared to CDMA95A systems, forward power control in CDMA2000-1X systems, on the one hand, is compatible with the forward power control mode of CDMA95A systems for RC1 and RC2, and on the other hand, incorporates fast forward link power control (FFLPC) into forward links for RC3-RC5 conditions. In IMT2000 standard, the fast closed-loop forward link power control mode at the adjustment speed of 800 Hz, 400 Hz and 200 Hz for RC3-RC5 conditions is used.

FFLPC may include an inner loop power control and an outer loop power control. The outer loop power control on the mobile station side and the inner loop power control by both the mobile station and base station may be described as follows. (1) In outer loop power control, the target FER is obtained at a period of 20 ms by estimating and adjusting the setpoint based on the signal-to-noise ratio (Eb/No) of the specified forward link. The adjustment of the setpoint can help the base station to obtain the appropriate power transmitting level in the forward link of inner loop power control. There are three forms of Eb/No setpoint: initial setpoint, maximum setpoint and minimum setpoint, which are sent to the mobile station by the base station in the form of a message. (2) In inner loop power control, the instruction of increasing or decreasing forward power control bit sent to the base station in the reverse link is determined by comparing the estimated Eb/No of the received signal in the forward traffic channel with the current setpoint for the outer power control. The highest adjustment speed of power control instructions can reach 800 Hz at most.

In an embodiment, mobile station 102 and base station 106 may be in a wireless communication session 120, where mobile station 102 and base station 106 are coupled via forward link 122 and reverse link 124. In one embodiment, wireless communication session 120 may be a voice communication session where voice messages are exchanged via forward link 122 and reverse link 124, as in a standard cellular telephone call. In another embodiment, wireless communication session 120 may be a data communication session where data packets, and the like, are exchanged via forward link 122 and reverse link 124 as in email, push-to-talk, internet browsing, and the like.

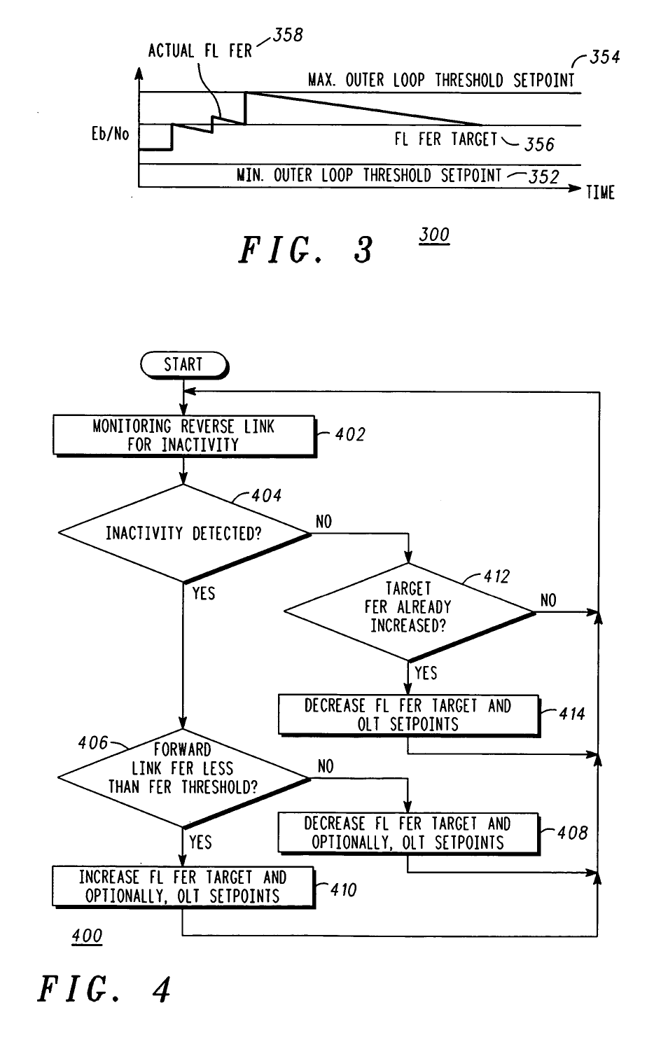

FIG. 2 representatively illustrates a wireless communication system 200 in accordance with an exemplary embodiment of the present invention. The wireless communication system 200 shown in FIG. 2 is a subset of the wireless communication system shown in FIG. 1. As will be described below, a reduction of the quality of service provided to a mobile user who is classified as at least one of an inattentive user or dormant user may be reduced to improve the CDMA wireless network's forward link capacity. In other words, the quality of service of an inattentive or dormant user of a mobile device may be selectively degraded in order to improve forward link capacity in a CDMA wireless network.

In an embodiment, base station 206 may monitor reverse link 224 of wireless communication session 120 for inactivity. In an embodiment, inactivity may include, but is not limited to, a user 203 of mobile station not talking and hence no voice activity taking place on reverse link 224. In this instance, the reverse link may consist of only eighth rate frames as opposed to whole frames due to the lack of voice activity of the user 203 of mobile station 202. An example of this embodiment may be one member in a conference call where the user 203 is muted such that the user 203 is not transmitting any voice data on the reverse link 224. In this embodiment, when inactivity is detected on the reverse link 224 in a voice communication session, user 203 may be an inattentive user as the user 203 is not using the reverse link 224, but instead may be passively listening to other subscriber's activities via forward link 222.

In another embodiment, inactivity may be after or between a data transmission between mobile station 202 and base station 206, such as during a push-to-talk session, data download, email, internet browsing, and the like. When inactivity is detected on the reverse link or forward link during a data communication session, a dormancy timer may begin. Inactivity may occur before and during the operation of a dormancy timer. In the prior art, the data communication session would end at the expiration of a time period of the dormancy timer. In this embodiment, user 203 may be a dormant user as the user is not using the reverse link 224 to request or transmit data, but instead may be finished with the data transfer or push-to-talk session.

In an embodiment, if inactivity is detected on reverse link 224, user 203 may be identified as an inattentive user if it is a voice communication session or when inactivity is detected on either the forward or reverse link, the user may be identified as a dormant user if it is a data communication session. For both types of sessions, forward link FER 223 may be measured by mobile station 202.

In an embodiment of the invention, the forward link FER 223 experienced by mobile station 202 may be communicated to base station 206 on reverse link 224. In one embodiment, forward link FER 223 may be communicated to base station 206 using a PMRM message 225.

In an embodiment, if forward link FER 223 is less than an FER threshold, the quality of service of the forward link 222 may be decreased since the user 203 is considered to be a dormant user or inattentive user who will not be affected by the reduction in quality of service. FER threshold may be a value of FER chosen by one skilled in the art to maintain a desired level of quality of service on forward link 222 in a given set of RF conditions. For example and without limitation, FER threshold may be chosen to be 1%, 2%, and the like. The comparison of forward link FER 223 to FER threshold may occur at either base station 206 or at mobile station 202.

FIG. 3 representatively illustrates a graphical representation 300 of a method of the invention in accordance with an exemplary embodiment of the present invention. The graph of FIG. 3 represents the outer loop threshold setpoints at the mobile station 202, which in an embodiment may be the signal-to-noise ratio (Eb/No) as set by the base station 206 and transmitted to the mobile station 102. As is known in the art, Eb/No value maps to an FER value.

As noted above, mobile station 202 uses a measured value of forward link FER to determine the signal-to-noise ratio required to maintain a forward link FER target 356. In an embodiment, target FER 356 may be adjusted by base station 206 between the limits of the maximum outer-loop threshold setpoint 354 and the minimum outer-loop threshold setpoint 352.

In an embodiment, if inactivity in reverse link 224 is detected and forward link FER 223 is less than a threshold FER, quality of service of the forward link 222 may be decreased. In an embodiment, quality of service of forward link 222 may be decreased by the base station 206 by increasing the forward link FER target 356 at the mobile station 202. In another embodiment, quality of service of forward link 222 may be decreased by increasing one or both of the minimum outer-loop threshold setpoint 352 and the maximum outer-loop threshold setpoint 354, thereby increasing the upper end to which forward link FER target (FL FER target) 356 may float.

This allows the mobile station to operate at a higher FER, thereby reducing the transmit power required of the base station for forward link 222, and reducing interference with other wireless signals transmitted or received by base station. This may significantly increases the forward link capacity of base station 206.

In an exemplary implementation of the invention, an inattentive user on a conference call will have the forward link quality of service degraded while inactivity is detected on the reverse link. This may not be a problem for the inattentive user, as the user may not be paying much attention to activity on the conference call anyway. If the inattentive user decides to become an attentive user by, for example by un-muting, then the quality of service of the forward link may be quickly returned to a higher quality of service by via the usual FFLPC methods. By employing a FER threshold and degrading the user only when the user's FER is less than the set threshold, the user can be quickly returned to the desired level of quality of service.

In another exemplary embodiment, in a data communication session, decreasing the quality of service of the forward link may begin occurring when the dormancy timer begins. In this way, the forward link quality of service is degraded during expiration of the dormancy timer. This is a departure from the prior art where the normal, high quality of service was maintained throughout the duration of the dormancy timer. In accordance with the embodiment of the invention, the forward link quality of service may decrease during the expiration of the dormancy timer, thereby increasing forward link capacity during the dormancy timer.

FIG. 4 representatively illustrates a flow diagram 400 in accordance with an exemplary embodiment of the present invention. In step 402, the reverse link of a wireless communication session between a mobile station and a base station may be monitored for inactivity. In step 404, it is determined if inactivity of the reverse link is detected. If not, it means that reverse link is active and forward link should be providing normal quality of service. In this case per step 412, it is determined if target FER has already been increased for the mobile station (thereby decreasing forward link quality of service). This may have been due to previous inactivity on the reverse link. If target FER had been previously increased, then per step 414, target FER is decreased, along with outer-loop threshold (OLT) setpoints if they too have been increased.

If inactivity is detected in step 404, it is determined per step 406 if forward link FER is less than an FER threshold. If so, forward link FER target is increased and optionally OLT setpoints as well (min and/or maximum OLT setpoints) in step 410. If forward link FER is not less than the threshold FER per step 406, forward link FER target is decreased and optionally OLT setpoints as well in step 408.

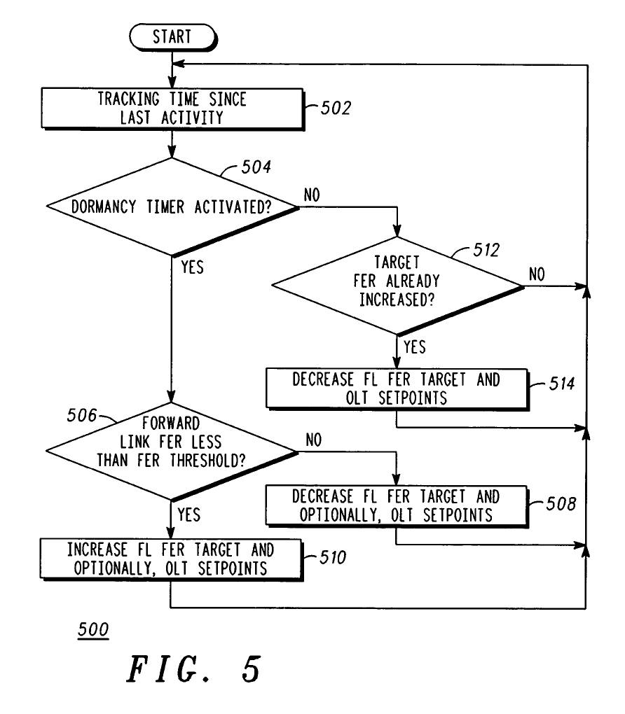

FIG. 5 representatively illustrates a flow diagram 500 in accordance with an exemplary embodiment of the present invention. In step 502, time since the last activity on reverse link is monitored. In step 504, it is determined if a dormancy timer is activated for a data communication session. If not, it means that reverse link is active and forward link should be providing normal quality of service. In this case per step 512, it is determined if target FER has already been increased for the mobile station (thereby decreasing forward link quality of service). This may have been due to previous inactivity on the reverse link or activation of the dormancy timer. If target FER had been previously increased, then per step 514, target FER is decreased, along with outer-loop threshold (OLT) setpoints if they too have been increased.

If inactivity is detected in step 504, it is determined per step 506 if forward link FER is less than an FER threshold. If so, forward link FER target is increased and optionally OLT setpoints as well (min and/or maximum OLT setpoints) in step 510. If forward link FER is not less than the threshold FER per step 506, forward link FER target is decreased and optionally OLT setpoints as well in step 508.

In the foregoing specification, the invention has been described with reference to specific exemplary embodiments; however, it will be appreciated that various modifications and changes may be made without departing from the scope of the present invention as set forth in the claims below. The specification and figures are to be regarded in an illustrative manner, rather than a restrictive one and all such modifications are intended to be included within the scope of the present invention. Accordingly, the scope of the invention should be determined by the claims appended hereto and their legal equivalents rather than by merely the examples described above.

For example, the steps recited in any method or process claims may be executed in any order and are not limited to the specific order presented in the claims. Additionally, the components and/or elements recited in any apparatus claims may be assembled or otherwise operationally configured in a variety of permutations to produce substantially the same result as the present invention and are accordingly not limited to the specific configuration recited in the claims.

Benefits, other advantages and solutions to problems have been described above with regard to particular embodiments; however, any benefit, advantage, solution to problem or any element that may cause any particular benefit, advantage or solution to occur or to become more pronounced are not to be construed as critical, required or essential features or components of any or all the claims.

As used herein, the terms “comprise”, “comprises”, “comprising”, “having”, “including”, “includes” or any variation thereof, are intended to reference a non-exclusive inclusion, such that a process, method, article, composition or apparatus that comprises a list of elements does not include only those elements recited, but may also include other elements not expressly listed or inherent to such process, method, article, composition or apparatus. Other combinations and/or modifications of the above-described structures, arrangements, applications, proportions, elements, materials or components used in the practice of the present invention, in addition to those not specifically recited, may be varied or otherwise particularly adapted to specific environments, manufacturing specifications, design parameters or other operating requirements without departing from the general principles of the same.

We claim:

1. A method of improving CDMA capacity through selective quality of service reduction between a mobile station and a base station in a wireless communication system, comprising:
monitoring a reverse link of a wireless communication session for inactivity;
if the inactivity is detected on the reverse link, identifying a user of the wireless communication session as at least one of an inattentive user and a dormant user;
measuring a forward link FER of the wireless communication session corresponding to the reverse link; and
if the forward link FER is less than an FER threshold, decreasing a quality of service of a forward link.

2. The method of claim 1, wherein if the wireless communication session is a voice communication session, identifying the user as an inattentive user.

3. The method of claim 1, wherein if the wireless communication session is a data communication session, identifying the user as a dormant user.

4. The method of claim 1, wherein decreasing the quality of service of the forward link comprises increasing the forward link FER target.

5. The method of claim 1, wherein decreasing the quality of service of the forward link comprises increasing at least one of a minimum and maximum outer loop threshold setpoints at the mobile station.

6. The method of claim 1, wherein if the wireless communication session is a data communication session, decreasing the quality of service of the forward link substantially at the same time as beginning a dormancy timer.

7. The method of claim 1, wherein the wireless communication system is a CDMA wireless communication system.

8. In a mobile station of a wireless communication system, a method of quality of service reduction between the mobile station and a base station, comprising:
the mobile station demonstrating inactivity to the base station on a reverse link of a wireless communication session;
identifying a user of the wireless communication session as at least one of an inattentive user and a dormant user;
measuring a forward link FER of the wireless communication session corresponding to the reverse link; and
if the forward link FER is less than an FER threshold, decreasing a quality of service of a forward link.

9. The mobile station of claim 8, wherein if the wireless communication session is a voice communication session, identifying the user as an inattentive user.

10. The mobile station of claim 8, wherein if the wireless communication session is a data communication session, identifying the user as a dormant user.

11. The mobile station of claim 8, wherein decreasing the quality of service of the forward link comprises increasing the forward link FER target.

12. The mobile station of claim 8, wherein decreasing the quality of service of the forward link comprises increasing at least one of a minimum and maximum outer loop threshold setpoints at the mobile station.

13. The mobile station of claim 8, wherein if the wireless communication session is a data communication session, decreasing the quality of service of the forward link substantially at the same time as beginning a dormancy timer.

14. The mobile station of claim 8, wherein the mobile station is coupled to operate on a CDMA wireless communication system.

15. In a base station of a wireless communication system, a method of quality of service reduction between the base station and a mobile station, comprising:
monitoring a reverse link of a wireless communication session for inactivity;
if the inactivity is detected on the reverse link, identifying a user of the wireless communication session as at least one of an inattentive user and a dormant user;
receiving a forward link FER of the wireless communication session corresponding to the reverse link; and
if the forward link FER is less than an FER threshold, decreasing a quality of service of a forward link.

16. The base station of claim 15, wherein if the wireless communication session is a voice communication session, identifying the user as an inattentive user.

17. The base station of claim 15, wherein if the wireless communication session is a data communication session, identifying the user as a dormant user.

18. The base station of claim 15, wherein decreasing the quality of service of the forward link comprises increasing the forward link FER target.

19. The base station of claim 15, wherein decreasing the quality of service of the forward link comprises increasing at least one of a minimum and maximum outer loop threshold setpoints at the mobile station.

20. The base station of claim 15, wherein if the wireless communication session is a data communication session, decreasing the quality of service of the forward link substantially at the same time as beginning a dormancy timer.
